(19) United States
(12) Patent Application Publication
(10) Pub. No.: US 2025/0288015 A1
(43) Pub. Date: Sep. 18, 2025

(54) MODULAR AEROSOL-GENERATING DEVICE

(71) Applicant: Philip Morris Products S.A., Neuchatel (CH)

(72) Inventors: Guo YU, Shenzhen (CN); Lizhang YANG, Shenzhen (CN); Hong Meng TIAN, Shenzhen (CN)

(73) Assignee: Philip Morris Products S.A., Neuchatel (CH)

(21) Appl. No.: 18/861,368

(22) PCT Filed: Jul. 15, 2022
(86) PCT No.: PCT/CN2022/105990

§ 371 Date: Oct. 29, 2024

(51) Int. Cl. A24F 40/53; A24F 40/40; A24F 40/57; H05B 1/02

(52) U.S. Cl. CPC A24F 40/53; A24F 40/40; A24F 40/57; H05B 1/0252

(57) ABSTRACT

An apparatus including a controller for an aerosol-generating device is provided, the controller including: a first connector configured to removably operably couple a component of a first type to the controller; and a second connector configured to removably operably couple a component of a second type to the controller, the controller being further configured to control the component of the first type, and the component of the second type, when coupled to the controller, and the controller being further configured to authenticate the component of the first type or the component of the second type coupled to the controller.

The invention relates to apparatus and methods for use in conjunction with modular aerosol-generating devices.

Many current designs of aerosol generating devices do not have a clear separation between heater, control, and battery portions, all of which are housed in one housing. Should even one part of such a device malfunction, for example an aged battery, the whole device needs to be discarded, which is not environmentally friendly. Furthermore, with the current designs, consumers need to purchase a new whole device if there is any new version of the product.

It would be desirable to have a modular design for aerosol generating devices. To better address one or more of these concerns, the present disclosure provides apparatus and methods for use in conjunction with modular aerosol-generating devices.

According to a first aspect of the invention, there is provided an apparatus comprising a control module for a modular aerosol-generating device. The control module may comprise a first connector configured to removably operably couple a module of a first type to the control module. The control module may comprise a second connector configured to removably operably couple a module of a second type to the control module. The control module may be configured to control the modules of the first and/or second type when coupled to the control module.

The control module may be configured to detect a subtype of the module of the first type coupled to the control module and to control the coupled module of the first type based on the detected subtype. Similarly, the control module may be configured to detect a subtype of the module of the second type coupled to the control module and to control the coupled module of the second type based on the detected subtype. The control module may be configured to obtain operating instructions for the coupled module of the first or second type based on the detected subtype, and to use the obtained operating instructions to control the coupled module. Stated differently, the control module may be configured to respond to the coupling of the module of the first or second type by obtaining and using subtype-appropriate operating instructions for the coupled module. The operating instructions may comprise firmware for the detected subtype.

The control module may be configured to store operating instructions for one or more of the subtypes of modules of the first or second type. The control module may further comprise storage for storing the operating instructions. Additionally or alternatively, the apparatus may further comprise communications circuitry, the control module being configured to obtain the operating instructions by using the communications circuitry to download the operating instructions from an external computing device. The external computing device may comprise for example a personal computing device, a remote server such as a cloud server, or the like.

The control module may be configured to detect a subtype of the module of the first or second type coupled to the control module based on data transferred from the coupled module. Such data transfer may take place during a handshake protocol.

The control module may be configured to authenticate the module of the first or second type coupled to the control module. The control module may be configured to authenticate the module of the first or second type based on one or more credentials provided to the control module. Additionally or alternatively, the control module may be configured to authenticate the module of the first or second type based on one or more certificates provided to the control module.

The module of the first type may be one of a plurality of interchangeable modules of the first type. The control module may be configured to enable a user to reconfigure the modular aerosol generating device by selectively interchanging modules of the first type. Similarly, the module of the second type may be one of a plurality of interchangeable modules of the second type. The control module may be configured to enable a user to reconfigure the modular aerosol generating device by selectively interchanging modules of the second type. The first type may be different to the second type.

Modules of the first type may comprise heater modules. Subtypes of the heater modules may be based on heating technology used by the heater modules. The subtype of a heater module may indicate that the heater module uses one or more heating technologies comprising: resistive heating technology; inductive heating technology; infra-red heating technology.

Modules of the second type may comprise power source modules. Subtypes of the power source modules may be based on power source technology used by the power source module.

The control module may be configured to permit interchange of heater modules using different heating technology, and/or to permit interchange of power source modules using different power source technology.

The apparatus may further comprise at least a module of a third type. One example of a module of a third may comprise a module used for extraction of data (usage data, failure data, and the like) from the control module, for example during repair.

The apparatus may further comprise at least one of the modules of the first and/or second type, optionally wherein the at least one module comprises one or more of storage, control circuitry, and communications circuitry.

The apparatus may further comprise the modules of the first and second type, wherein the control, first and/or second modules have the same size. Additionally or alternatively, the control, first and/or second modules have the same cross-sectional area. Additionally or alternatively, the control, first and/or second modules have the same cross-sectional profile.

The control, first and/or second modules comprise the same or corresponding connectors. In this way, the device may be made so that it is unimportant which of the two connectors of the control module is used for which type of module, e.g., so that it does not matter to which end of the control module the user connects the heater module or power source module, respectively.

The first connector may be located at or towards a first end of the control module. The second connector may be located at or towards a second end of the control module. The first end may oppose the second end. This may advantageously make connecting the module of the first type and the module of the second type to the control module easier.

The first connector and the second connector may be the same type of connector. This may advantageously mean that it does not matter to which end of the control module the user connects the module of the first type and the module of the second type, respectively.

At least one of the connectors of the control module, for example at least one of the first connector and the second connector, may be configured to form a connector pair with a complementary connector of the respective module of the first or second type. The connector pair may be configured to provide a mechanical connection between the control module and the respective module of the first or second type. Additionally or alternatively, the connector pair may be configured to provide an electrical connection between the control module and the respective of the first or second type module. Additionally or alternatively, the connector pair may be configured to provide an optical connection between the control module and the respective module of the first or second type. As used herein, “optical connection” may refer to a connection for the optical communication of data using light to carry information, for example using an LED and a photodiode.

The connector pair may be configured to enable data transfer between the control module and the respective module of the first or second type. Additionally or alternatively, the connector pair may be configured to enable power transfer between the control module and the respective module of the first or second type. The connector pair may be configured to enable transfer of both power and data between the control module and the respective module of the first or second type.

One of the connectors of the connector pair may be a male connector and the other connector may be a female connector. Alternatively, the connectors of the connector pair may be neither male nor female. For example, the connectors may comprise magnetic connectors, which may be neither male nor female.

One of the connectors of the connector pair may comprise a first retention element configured to reversibly engage a corresponding second retention element on the other connector of the connector pair. One of the first and second retention elements may comprise an indentation. The other of the first and second retention elements may comprise a protrusion configured to engage the indentation. The protrusion may comprise a ridge and the indentation may comprise a groove. At least one of the first and second retention elements may be resiliently deflectable to allow the first retention element to reversibly engage the second retention element. The resiliently deflectable retention element may comprise a cantilever which may be resiliently deflectable from an engaged position to a released position. The resiliently deflectable retention element may comprise a base to which the cantilever is mounted, for example at an oblique angle. At least one of the first and second retention elements may comprise a friction-enhancing material for increasing friction between the retention elements.

At least one of the modules may comprise an extendable part which may be configured to be movable between an extended position and a retracted position. The extendable part may be configured to engage another of the modules when in the extended position and to release the other module when in the retracted position. The extendable part may be configured to be movable from the extended position to the retracted position by compression of a region of a housing of the at least one module.

The apparatus may further comprise the module of the first type and/or the module of the second type which are couplable to the control module to form a modular aerosol-generating device. The modular aerosol-generating device thus formed may constitute a second aspect of the invention.

According to a third aspect of the invention, there is provided an aerosol generating system comprising: the aerosol generating device of the second aspect; and an aerosol generating article.

According to a fourth aspect of the invention, there is provided a method of controlling a modular aerosol-generating device, for example the aerosol-generating device of the second aspect. The method may comprise controlling a module of a first type removably coupled to the control module. The method may further comprise controlling a module of a second type removably coupled to the control module.

The method may comprise detecting a subtype of the module of the first type coupled to the control module and controlling the coupled module of the first type based on the detected subtype. Similarly, the method may comprise detecting a subtype of the module of the second type coupled to the control module and controlling the coupled module of the second type based on the detected subtype. The method may comprise obtaining operating instructions for the coupled module of the first or second type based on the detected subtype, and using the obtained operating instructions to control the coupled module. Stated differently, the method may comprise responding to the coupling of the module of the first or second type by obtaining and using subtype-appropriate operating instructions for the coupled module. The operating instructions may comprise firmware for the detected subtype.

The method may comprise storing operating instructions for one or more of the subtypes of modules of the first or second type. Additionally or alternatively, the method may comprise obtaining the operating instructions by downloading the operating instructions from an external computing device.

The method may comprise detecting a subtype of the module of the first or second type coupled to the control module based on data transferred from the coupled module.

The method may comprise authenticating the module of the first or second type coupled to the control module. The method may comprise authenticating the module of the first or second type based on one or more provided credentials. Additionally or alternatively, the method may comprise authenticating the module of the first or second type based on one or more provided certificates.

According to a fifth aspect of the invention, there is provided a computing system configured to perform the method of the fourth aspect.

According to a sixth aspect of the invention, there is provided a computer program comprising instructions which, when executed by a computing system, cause the computing system to perform the method of the fourth aspect.

According to a seventh aspect of the invention, there is provided a computer-readable medium comprising instructions which, when executed by a computing system, cause the computing system to perform the method of the fourth aspect.

Below, there is provided a non-exhaustive list of non-limiting examples. Any one or more of the features of these examples may be combined with any one or more features of another example, embodiment, or aspect described herein.

Ex. 1. An apparatus comprising a control module for a modular aerosol-generating device, the control module comprising:
a first connector configured to removably operably couple a module of a first type to the control module; and
a second connector configured to removably operably couple a module of a second type to the control module;
wherein the control module is configured to control the module of the first type and the module of the second type when coupled to the control module.

Ex.2. The apparatus of Ex. 1, wherein the control module is configured to detect a subtype of the module of the first type coupled to the control module and to control the coupled module of the first type based on the detected subtype.

Ex.3. The apparatus of Ex. 1 or Ex.2, wherein the control module is configured to detect a subtype of the module of the second type coupled to the control module and to control the coupled module of the second type based on the detected subtype.

Ex.4. The apparatus of Ex.2 or Ex.3, wherein the control module is configured to obtain operating instructions for the coupled module of the first type, or for the coupled module of the second type, based on the detected subtype, and to use the obtained operating instructions to control the coupled module.

Ex.5. The apparatus of Ex.4, wherein the operating instructions comprise firmware for the detected subtype.

Ex.6. The apparatus of Ex.4 or Ex.5, wherein the control module is configured to store operating instructions for one or more of the subtypes of module of the first type and/or for one or more of the subtypes of the module of the second type.

Ex.7. The apparatus of Ex.6, wherein the control module further comprises storage for storing the operating instructions.

Ex.8. The apparatus of any of Ex.4-Ex.7, further comprising communications circuitry, the control module being configured to obtain the operating instructions by using the communications circuitry to download the operating instructions from an external computing device. The external computing device may comprise for example a personal computing device, a remote server such as a cloud server, and the like.

Ex.9. The apparatus of any of Ex. 1-Ex.8, wherein the control module is configured to respond to the coupling of the module of the first type and/or the module of the second type by obtaining and using subtype-appropriate operating instructions for the coupled module.

Ex. 10. The apparatus of any of Ex. 1-Ex.9, wherein the control module is configured to detect a subtype of the module of the first type and/or the module of the second type coupled to the control module based on data transferred from the coupled module.

Ex. 11. The apparatus of any of Ex. 1-Ex. 10, wherein the control module is configured to authenticate the module of the first type and/or the module of the second type coupled to the control module.

Ex. 12. The apparatus of any of Ex. 1-Ex. 11, wherein the control module is configured to authenticate the module of the first type and/or the module of the second type based on one or more credentials provided to the control module.

Ex. 13. The apparatus of any of Ex. 1-Ex. 12, wherein the control module is configured to authenticate the module of the first type and/or the module of the second type based on one or more certificates provided to the control module.

Ex. 14. The apparatus of any of Ex. 1-Ex. 13, wherein the module of the first type is one of a plurality of interchangeable modules of the first type, and wherein the control module is configured to enable a user to reconfigure the modular aerosol generating device by selectively interchanging modules of the first type.

Ex. 15. The apparatus of any of Ex. 1-Ex. 14, wherein the module of the second type is one of a plurality of interchangeable modules of the second type, and wherein the control module is configured to enable a user to reconfigure the modular aerosol generating device by selectively interchanging modules of the second type.

Ex. 16. The apparatus of any of Ex. 1-Ex. 15, wherein the first type is different to the second type.

Ex. 17. The apparatus of any of Ex. 1-Ex. 16, wherein modules of the first type comprise heater modules.

Ex. 18. The apparatus of Ex. 17, wherein subtypes of the heater modules are based on heating technology used by the heater modules.

Ex. 19. The apparatus of Ex. 18, wherein the subtype of a heater module indicates that the heater module uses one or more heating technologies comprising: resistive heating technology; inductive heating technology; infra-red heating technology.

Ex.20. The apparatus of any of Ex. 1-Ex. 19, wherein modules of the second type comprise power source modules.

Ex.21. The apparatus of Ex.20, wherein subtypes of the power source modules are based on power source technology used by the power source module.

Ex.22. The apparatus of any of Ex. 1-Ex.21, wherein the control module is configured to permit interchange of heater modules using different heating technology, and/or to permit interchange of power source modules using different power source technology.

Ex.23. The apparatus of any of Ex. 1-Ex.22, further comprising at least a module of a third type.

Ex.24. The apparatus of any of Ex. 1-Ex.23, further comprising at least one of the modules of the first type and/or at least one of the modules of the second type, wherein the at least one module of the first type and/or the at least one module of the second type comprises one or more of storage, control circuitry, and communications circuitry.

Ex.25. The apparatus of any of Ex. 1-Ex.24, further comprising the module of the first type and the module of the second type, wherein the control module, the module of the first type and/or the module of the second type have the same size.

Ex.26. The apparatus of any of Ex. 1-Ex.25, further comprising the module of the first type and the module of the second type, wherein the control module, the module of the first type and/or the module of the second type have the same cross-sectional area.

Ex.27. The apparatus of any of Ex. 1-Ex.26, further comprising the module of the first type and the module of the second type, wherein the control module, the module of the first type and/or the module of the second type have the same cross-sectional profile.

Ex.28. The apparatus of any of Ex. 1-Ex.27, further comprising the module of the first type and the module of the second type, wherein the control module, the module of the first type and/or the module of the second type comprise the same or corresponding connectors.

Ex.29. The apparatus of any of Ex. 1-Ex.28, wherein at least one of the connectors of the control module is configured to form a connector pair with a complementary connector of the module of the first type or a complementary connector of the module of the second type.

Ex.30. The apparatus of Ex.29, wherein the connector pair is configured to provide a mechanical connection between the control module and the module of the first type or the module of the second type.

Ex.31. The apparatus of Ex.29 or Ex.30, wherein the connector pair is configured to provide an electrical connection between the control module and the module of the first type or the module of the second type.

Ex.32. The apparatus of any of Ex.29-Ex.31, wherein the connector pair is configured to provide an optical connection between the control module and the module of the first type or the module of the second type.

Ex.33. The apparatus of any of Ex.29-Ex.32, wherein the connector pair is configured to enable data transfer between the control module and the module of the first type or the module of the second type.

Ex.34 The apparatus of any of Ex.29-Ex.33, wherein the connector pair is configured to enable power transfer between the control module and the module of the first type or the module of the second type.

Ex.35. The apparatus of any of Ex.29-Ex.34, wherein the connector pair is configured to enable transfer of both power and data between the control module and the module of the first type or the module of the second type.

Ex.36A. The apparatus of any of Ex.29-Ex.35, wherein one of the connectors of the connector pair is a male connector and the other connector is a female connector.

Ex.36B. The apparatus of any of Ex.29-Ex.35, wherein the connectors of the connector pair are neither male nor female.

Ex.36C. The apparatus of any of Ex.29-Ex.35 and Ex.36B, wherein the connectors comprise magnetic connectors.

Ex.37. The apparatus of any of Ex.29-Ex.36, wherein one of the connectors of the connector pair comprises a first retention element configured to reversibly engage a corresponding second retention element on the other connector of the connector pair.

Ex.38. The apparatus of Ex.37, wherein one of the first and second retention elements comprises an indentation and the other of the first and second retention elements comprises a protrusion configured to engage the indentation.

Ex.39. The apparatus of Ex.38, wherein the protrusion comprises a ridge and wherein the indentation comprises a groove.

Ex.40. The apparatus of any of Ex.37-Ex.39, wherein at least one of the first and second retention elements is resiliently deflectable to allow the first retention element to reversibly engage the second retention element.

Ex.41. The apparatus of Ex.40, wherein the resiliently deflectable retention element comprises a cantilever which is resiliently deflectable from an engaged position to a released position.

Ex.42. The apparatus of Ex.41, wherein the resiliently deflectable retention element comprises a base to which the cantilever is mounted at an oblique angle.

Ex.43. The apparatus of any of Ex.37-Ex.42, wherein at least one of the first and second retention elements comprises a friction-enhancing material for increasing friction between the retention elements.

Ex.44. The apparatus of any of Ex. 1-Ex.43, wherein at least one of the modules comprises an extendable part configured to be movable between an extended position and a retracted position, wherein the extendable part is configured to engage another of the modules when in the extended position and to release the other module when in the retracted position.

Ex.45. The apparatus of Ex.44, wherein the extendable part is configured to be movable from the extended position to the retracted position by compression of a region of a housing of the one module.

Ex.46. The apparatus of any of Ex. 1-Ex.45, further comprising the module of the first type and the module of the second type which are couplable to the control module to form a modular aerosol-generating device, optionally wherein each of the control module, the module of the first type, and the module of the second type have their own housings.

Ex.47. An aerosol generating system comprising:
the aerosol generating device of Ex.46; and
an aerosol generating article.

Ex.48. A method of controlling a modular aerosol-generating device, for example the aerosol-generating device of Ex.46, the method comprising:
controlling a module of a first type removably coupled to the control module; and
controlling a module of a second type removably coupled to the control module.

Ex.49. The method of Ex.48, comprising detecting a subtype of the module of the first type coupled to the control module and controlling the coupled module of the first type based on the detected subtype.

Ex.50. The method of Ex.48 or Ex.49, comprising detecting a subtype of the module of the second type coupled to the control module and controlling the coupled module of the second type based on the detected subtype.

Ex.51. The method of Ex.49 or Ex.50, comprising obtaining operating instructions for the coupled module of the first type or the coupled module of the second type based on the detected subtype, and using the obtained operating instructions to control the coupled module.

Ex.52. The method of Ex.51, wherein the operating instructions comprise firmware for the detected subtype.

Ex.53. The method of Ex.51 or Ex.52, comprising storing operating instructions for one or more of the subtypes of module of the first type and/or for one or more of the subtypes of module of the second type.

Ex.54. The method of any of Ex.51-Ex.53, comprising obtaining the operating instructions by downloading the operating instructions from an external computing device.

Ex.55. The method of any of Ex.48-Ex.54, comprising responding to the coupling of the module of the first or second type by obtaining and using subtype-appropriate operating instructions for the coupled module.

Ex.56. The method of any of Ex.48-Ex.55, comprising detecting a subtype of the module of the first type, or a subtype of the module of the second type, coupled to the control module based on data transferred from the coupled module.

Ex.57. The method of any of Ex.48-Ex.56, comprising authenticating the module of the first type, or the module of the second type, coupled to the control module.

Ex.58. The method of any of Ex.48-Ex.57, comprising authenticating the module of the first type, or the module of the second type, based on one or more provided credentials.

Ex.59. The method of any of Ex.48-Ex.58, comprising authenticating the module of the first type, or the module of the second type, based on one or more provided certificates.

Ex.60. A computing system configured to perform the method of any of Ex.48-Ex.59.

Ex.61. A computer program comprising instructions which, when executed by a computing system, cause the computing system to perform the method of any of Ex.48-Ex.59.

Ex.62. A computer-readable medium comprising instructions which, when executed by a computing system, cause the computing system to perform the method of any of Ex.48-Ex.59.

In another aspect, there is provided an aerosol-generating device comprising an outer housing, wherein the housing houses three modules comprising: (1) a heater module; (2) a main PCBA module; and (3) a battery module, wherein each module has its own housing, and wherein each module is connected with other modules via a connector. In yet another aspect, there is provided an aerosol-generating device comprising three main modules: (1) a heater module; (2) a main PCBA module; and (3) a battery module, wherein each module has its own housing, and wherein each module is connected with other modules via a connector.

The modular design of aerosol-generating device as described herein permits the consumer to interchange the heating methods, for example from heating blade to inductive coil heating, or to repair or replace a malfunctioning module, without replacing the whole device. The modular design facilitates standardization and unification among different versions and platforms. The modular design facilitates manufacture, assembly, and maintenance of modules.

Standardization of the connector arrangement as well as the interlock between the modules facilitates reduction of the assembly time and the interchange of different modules. Modularity can increase the versatility for use cases of the aerosol-generating device.

Automatic selection of appropriate operating instructions for the coupled modules based on their type and/or subtype facilitates the implementation of a modular design of aerosol-generating device via increased intelligence of the control module and increased interchangeability of the couplable modules, while providing more flexibility to the user in the choice of technology used by the couplable modules.

The term “circuitry”, as used herein, may comprise, for example, singly or in any combination, hardwired circuitry, programmable circuitry such as computer processors comprising one or more individual instruction processing cores, state machine circuitry, and/or firmware that stores instructions executed by programmable circuitry. Modules may, collectively or individually, be embodied as circuitry that forms a part of one or more devices or systems as described herein.

The term “obtaining”, as used herein, may comprise, for example, receiving from another system, device, or process; receiving via an interaction with a user; loading or retrieving from storage or memory; measuring or capturing using sensors or other data acquisition devices.

The indefinite article “a” or “an” does not exclude a plurality. In addition, the articles “a” and “an” as used herein should generally be construed to mean “one or more” unless specified otherwise or clear from the context to be directed to a singular form.

Unless specified otherwise, or clear from the context, the phrases “one or more of A, B and C”, “at least one of A, B, and C”, and “A, B and/or C” as used herein are intended to mean all possible permutations of one or more of the listed items. That is, the phrase “A and/or B” means (A), (B), or (A and B), while the phrase “A, B, and/or C” means (A), (B), (C), (A and B), (A and C), (B and C), or (A, B, and C).

The term “comprising” does not exclude other elements or steps. Furthermore, the terms “comprising”, “including”, “having” and the like may be used interchangeably herein.

The invention may include one or more aspects, examples or features in isolation or combination whether specifically disclosed in that combination or in isolation. Any optional feature or sub-aspect of one of the above aspects applies as appropriate to any of the other aspects.

These and other aspects of the invention will be apparent from and elucidated with reference to the embodiments described hereinafter.

A detailed description will now be given, by way of example only, with reference to the accompanying drawings, in which:

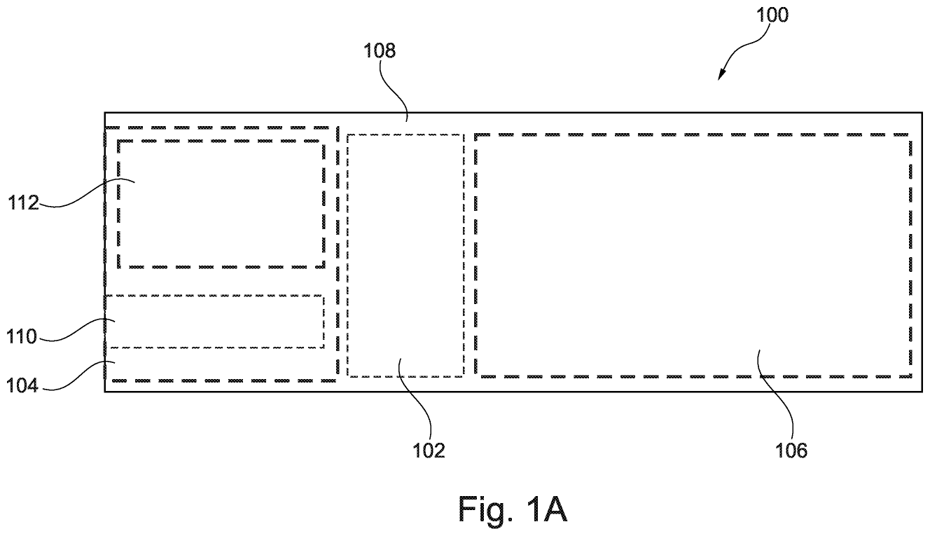

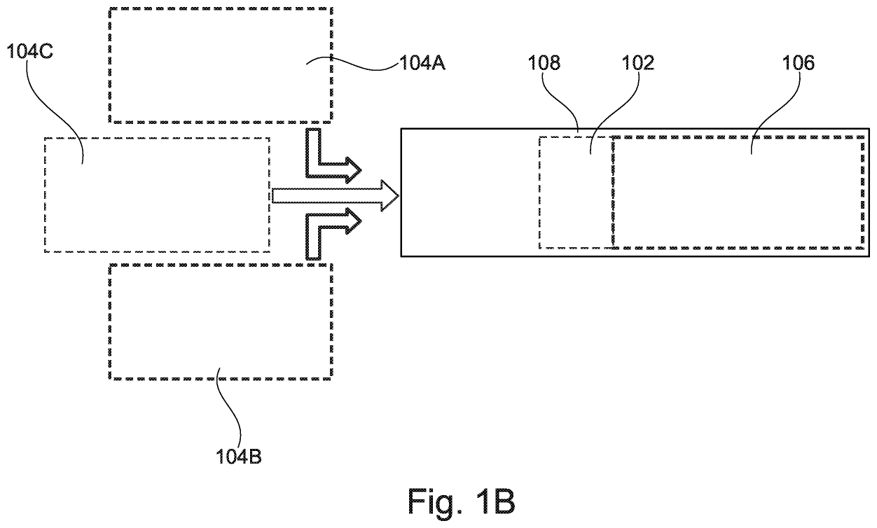

FIGS. 1A and 1B illustrate a modular aerosol-generating device according to the present disclosure;

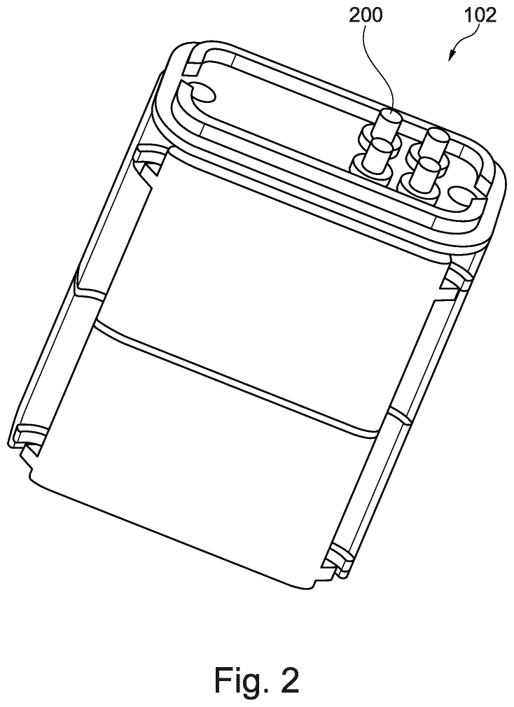

FIG. 2 illustrates in more detail a control module of the aerosol-generating device of FIGS. 1A and 1B;

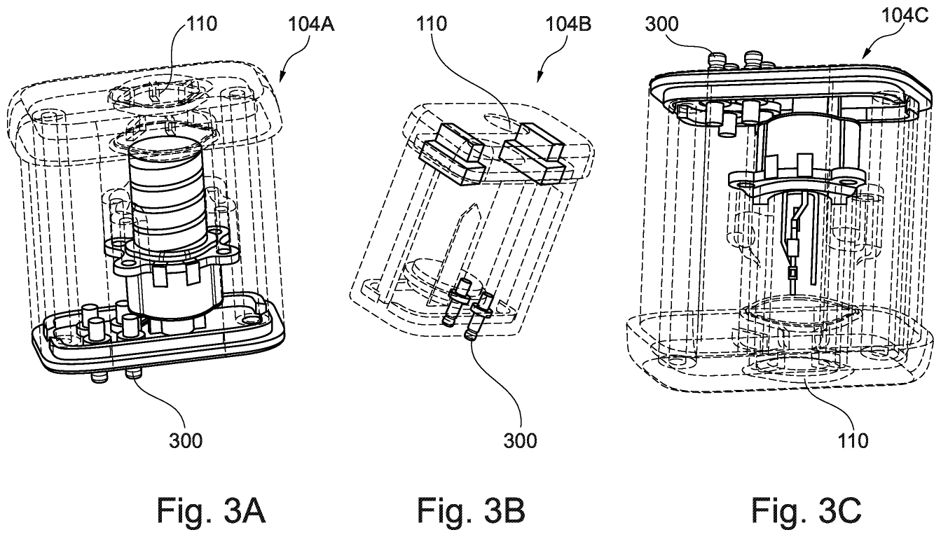

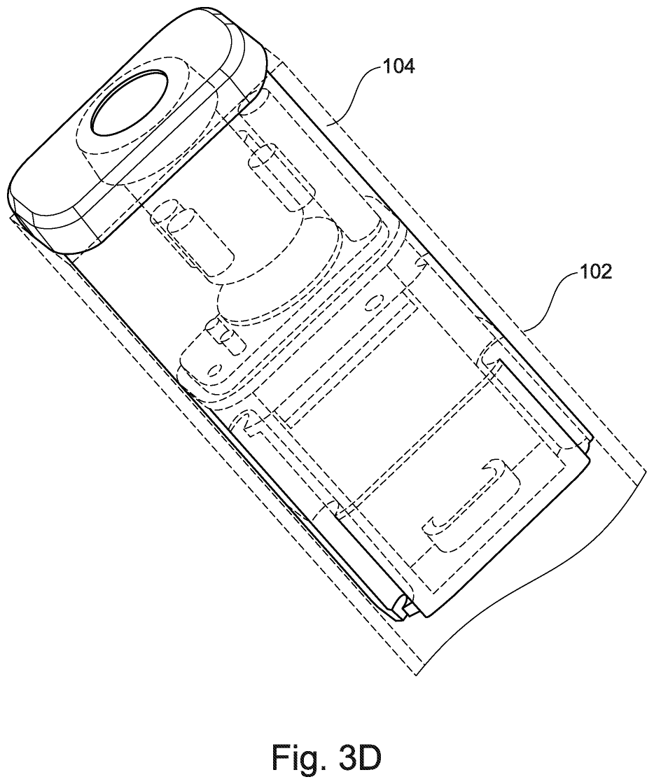

FIGS. 3A-D illustrate in more detail interchangeable heater modules of the aerosol-generating device of FIGS. 1A and 1B;

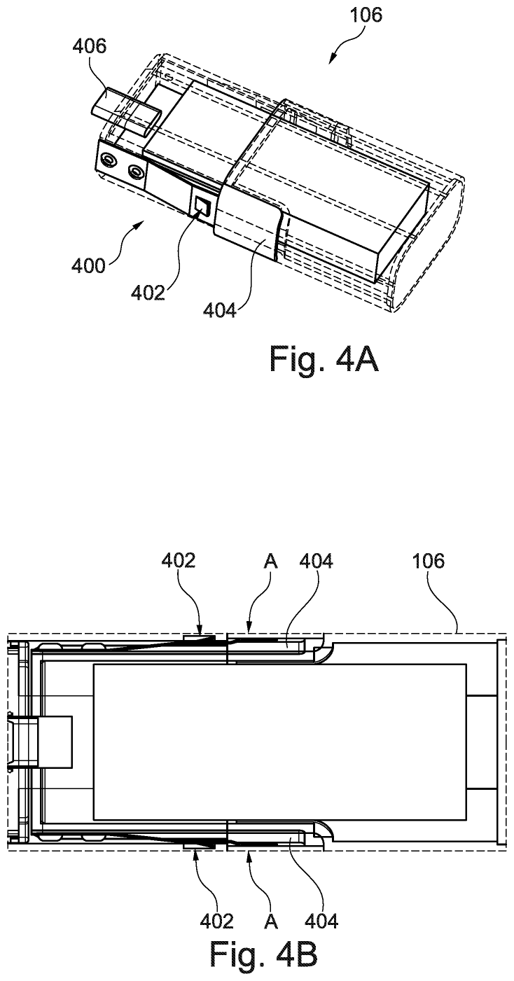

FIGS. 4A and 4B illustrate the power source module of the aerosol-generating device of FIGS. 1A and 1B;

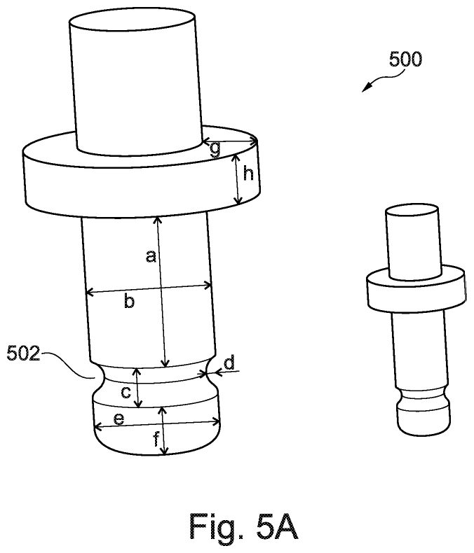

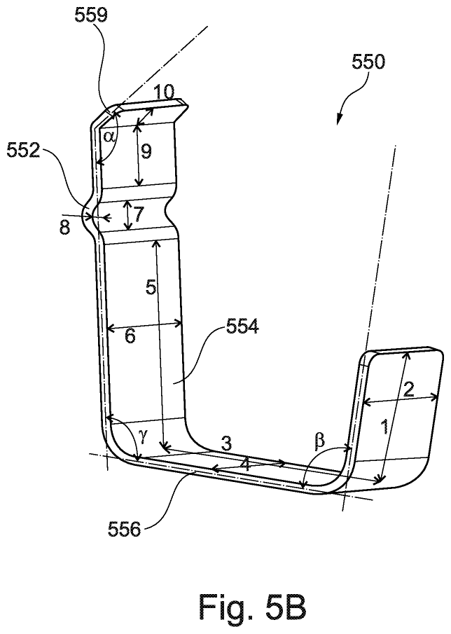

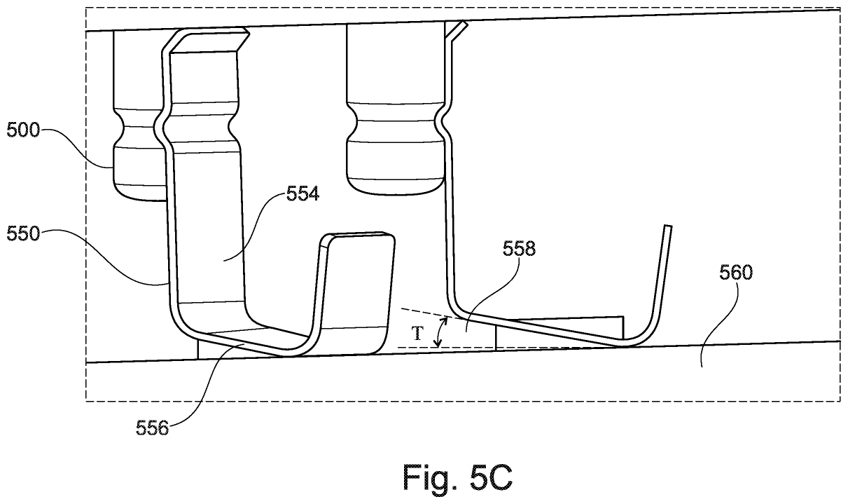

FIGS. 5A-C illustrate a connector arrangement according to the present disclosure;

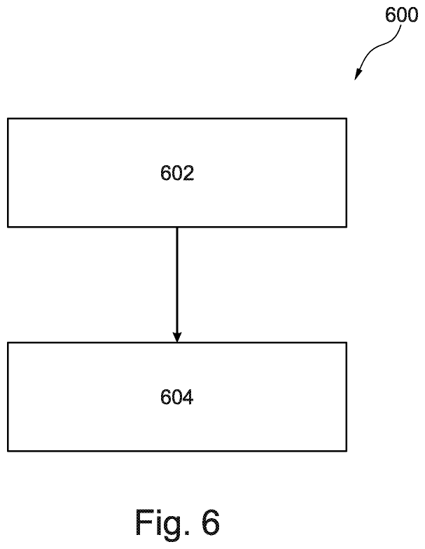

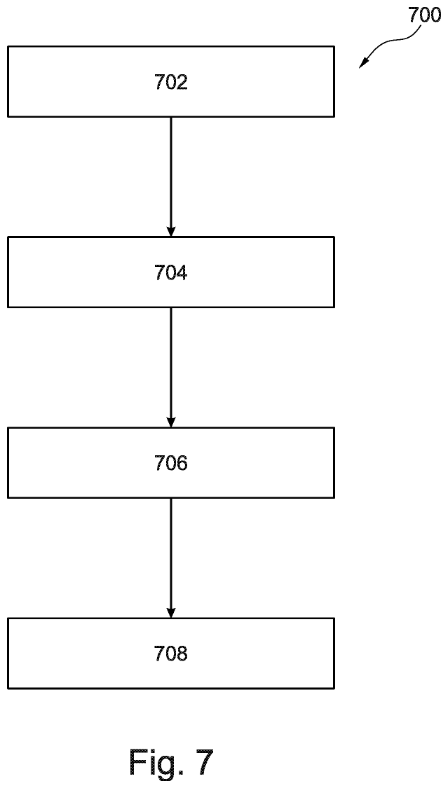

FIGS. 6 and 7 are flowcharts illustrating methods according to the present disclosure; and

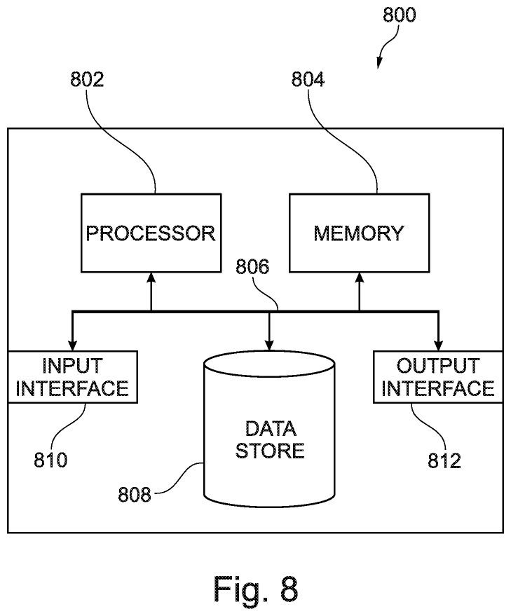

FIG. 8 illustrates a computing system that can be used in accordance with the systems and methods disclosed herein.

FIGS. 1A and 1B illustrate a modular aerosol-generating device 100 according to the present disclosure. The modular aerosol-generating device 100 comprises a control module 102, a heater module 104, and a power source module 106. The heater module 104 and the power source module 106 are joined reversibly to the control module 102. A main housing 108 may house the modules. Any one or more of the modules may also include their own individual housings.

The aerosol-generating device 100 is designed as a handheld device that can be used by a user for consuming, for instance in one or more usage sessions (also referred to as “experiences” or “experience sessions”), aerosol generated by an aerosol-generating article (not shown). Usually, aerosol-generating articles comprise an aerosol-forming substrate, such as a tobacco containing substrate, and/or a cartridge comprising a liquid. The aerosol-forming substrate can comprise or be one or more of a liquid, a solid and a gel. For generating the aerosol during use or consumption, heat is provided by the heater module to heat at least a portion of the aerosol-forming substrate. Exemplary aerosol-generating articles for use with aerosol-generating devices can comprise an aerosol-forming substrate that is assembled, often with other elements or components, in the form of a stick. Such a stick can be configured in shape and size to be inserted at least partially into the aerosol-generating device, more particularly at least partially into the heater module. Other exemplary aerosol-generating articles can comprise a cartridge containing a liquid that can be vaporized during aerosol consumption by the user. Also, such a cartridge can be configured in shape and size to be inserted at least partially into the aerosol-generating device. Alternatively, the cartridge may be fixedly mounted to the aerosol-generating device and refilled by inserting liquid into the cartridge.

The aerosol-generating device 100 is provided with a modular design. The heater module 104 is one of a plurality of interchangeable heater modules. FIG. 1B depicts one non-limiting example comprising three interchangeable heater modules 104A, 104B, and 104C. The heater module 104A comprises an electromagnetic induction heating engine. The heater module 104B comprises a resistive heating engine, which comprises a resistively heated element. The resistively heated element may be a heater blade or pin for heating an aerosol-generating article internally. The resistively heated element may be an external heater, e.g. a heater rolled into a tube into which the aerosol-generating article can be inserted. The heater module 104C comprises a heat wire engine, e.g. a coil wrapped around a wick. There are thus at least three subtypes of module of the type “heater”, each using a different heating technology. Although not shown in FIGS. 1A and 1B, the power source module 106 may represent one of a plurality of interchangeable power source modules, using different power source technology. The control module 102 is configured to enable the user to reconfigure the modular aerosol generating device 100 by selectively interchanging the heater and/or power source modules, for example to interchange heater modules using different heating technology and/or to interchange power source modules using different power source technology.

FIG. 2 shows the control module 102. The control module 102 comprises at least one connector (not shown) configured to removably operably couple the power source module 106 to the control module 102. The connector (not shown) may be a male connector for connecting with a female connector of the power source module 106, or a female connector for connecting with a male connector of the power source module 106.

In some embodiments, the female connector may be a female USB connector for connecting to a male USB connector of the power source module. In some embodiments, the male connector may be a male USB connector for connecting to a female USB connector of the power source module.

The control module 102 is further provided with at least one connector 200 configured to removably operably couple the heater module 104 to the control module 102. This connector may be a male connector as shown in FIG. 2, for connecting with a female connector of a heater module. Alternatively, the connector 200 may be a female connector for connecting with a male connector of a heater module 104, for example the connector 200 may be a female connector for connecting with a male connector 300 of one of the heater modules 104A, 104B, 104C of FIGS. 3A, 3B, 3C.

In some embodiments, the female connector may be a female USB connector for connecting to a male USB connector of the heater module. In some embodiments, the male connector may be a male USB connector for connecting to a female USB connector of the heater module.

The control module 102 comprises control circuitry (not shown) configured to control one or more functions of the aerosol-generating device 100, including functions of the heater module 104 and/or the power source module 106. The control circuitry may comprise one or more processors and/or microprocessors for data processing, and memory. The control module 102 further comprises data storage for storing data, for example preloaded firmware for various subtypes of heater module 104 and/or power source module 106, as described below. For communicating with each other and/or with an external computing device, each of the modules may comprise at least one communications interface. The communications interfaces can be configured for wireless communication, for wired communication, or both. For instance, the communications interfaces can be configured for communicative coupling via an Internet connection, a wireless LAN connection, a WiFi connection, a Bluetooth connection including BLE, a mobile phone network, a 3G/4G/5G connection and so on, an edge connection, an LTE connection, a BUS connection, a wireless connection, a wired connection, a radio connection, a near field connection, an loT connection or any other connection using any appropriate communication protocol. Additionally, the control module 102 may include at least one energy storage for storing electrical energy for use prior to coupling of the power source module 106. The control module 102 may have a width of 35.0 mm, and a depth of 20.0 mm. The housing of the control module 102, which may be main housing 108, may comprise any suitable material or combination of materials. Examples of suitable materials include metals, alloys, plastics or composite materials containing one or more of those materials, or thermoplastics that are suitable for food or pharmaceutical applications, for example polypropylene, polyetheretherketone (PEEK) and polyethylene. Preferably, the material is light and non-brittle. Preferably, the material is high temperature resistant and low toxicity.

The control module 102 is configured to detect coupling of the heater module 104 and/or coupling of the power source module 106 via the connectors. Moreover, the control module 102 is configured to detect a subtype of the coupled heater module 104 and to control the coupled heater module 104 based on the detected subtype. Additionally, the control module 102 is configured to detect a subtype of the coupled power source module 106 and to control the coupled power source module 106 based on the detected subtype. In particular, the control module 102 is configured to obtain firmware for the detected subtype of heater module 104 and/or for the detected subtype of power source module 106, and to use the obtained firmware to control the coupled modules. In one non-limiting example, the control module is configured to store firmware for different subtypes of heater module and/or power source module, and to retrieve the appropriate firmware from storage based on the detected subtype. The retrieved firmware is then used for controlling the heater module 104 and/or the power source module 106. The control module 102 may be configured to install the firmware prior to using it. In addition to, or instead of, firmware being prestored on the control module 102, the firmware may be retrieved from storage on the coupled modules and/or downloaded from an external data source, such as an external computing device, e.g., the cloud.

The control module 102 may be configured to detect the subtype of the modules based on data transferred from the coupled modules. In one example, the modules may exchange identification information such as model numbers during a handshake protocol performed after coupling, and the identification information may be used by the control module 102 to select the appropriate firmware. Data exchanged during the handshake protocol may be used to determine whether a coupled module is authentic or fake. The control module 102 may be configured to authenticate the coupled modules, based for example on one or more credentials and/or certificates provided to the control module 102. Such authentication information may be preinstalled on the modules by the manufacturer for use in subsequent authentication when the modules are first coupled to a control module. In one non-limiting example, the control module 102 may communicate with a certificate authority (CA) to obtain a digital certificate proving the validity of a public key prestored on the coupled module. The authentication can be one-way or two-way.

FIGS. 3A-C respectively illustrate the heater modules 104A-C. Each of the heater modules 104A-C comprises at least one male connector 300 for mating with at least one female connector of the control module 102. Thus, each of the heater modules 104A-C is configured for mating with a control module like that shown in FIG. 2 except where the connector 200 is a female connector. Each of the heater modules 104A-C has the same size and shape, or at least the same cross-sectional area and profile (without the housing), to facilitate their interchangeability. The volume of the modules may be the same or different. Any of the heater modules 104A-C may readily be coupled to the control module 102 using the connectors, as shown in FIG. 3D. The heater module 104 may have a width of 35.0 mm, a height of 35.0 mm, and a depth of 20.0 mm. The housing of the heater module 104 may be formed of the same material as that of one or more of the other modules. The heater module 104 comprises a receptacle 110 for an aerosol-generating article and circuitry 112 (as shown in FIG. 1A) for control and/or communications and/or data storage. The heater module 104 may comprise any suitable number of heating elements. For example, the heater module 104 may comprise two, three, four, five, or six or more heating elements. The heating element or heating elements may be arranged appropriately so as to most effectively heat the aerosol-generating substrate. The heating element may comprise an electrically resistive material such as a heating blade or heat wire. The heating element may alternatively comprise an infrared heating element, or an inductive heating element.

FIGS. 4A and 4B illustrate the power source module 106. The power source module 106 is configured to supply electrical energy to the aerosol-generating device 100, particularly to the heater module 104 and/or to the control module 102. The power source module 106 may comprise at least one energy storage for the aerosol-generating device 100. The at least one energy storage may, for example, comprise at least one battery, at least one accumulator, at least one capacitor, or any other energy storage. The at least one battery may be a nickel-metal hydride battery, a nickel cadmium battery, or a lithium based battery, for example a lithium-cobalt-oxide (LCO), a lithium-nickel-manganese-cobalt-oxide (NMC), a lithium-nickel-cobalt-aluminium-oxide (NCA), a lithium-iron-phosphate (LFP) or a lithium-polymer battery. The energy storage may be configured to supply the aerosol-generating device 100 with electrical energy. The energy storage may be (re) chargeable. Electrical energy may be provided to the energy storage by a companion device, for example, or from a power socket via a charger. The power source module 106 may comprise a battery connector for receiving a supply of electrical energy for recharging the energy storage. The power source module 106 may further comprise circuitry for control and/or communications and/or data storage. In one non-limiting example, the power source module 106 has a width of 35.0 mm, a height of 35.0 mm/45.0 mm, and a depth of 20.0 mm. The housing of the power source module 106 may be formed of the same material as that of one or more of the other modules.

FIGS. 4A and 4B also illustrate a module interlock 400 according to the present disclosure. The module interlock 400, shown here as forming part of the power source module 106, comprises an extendable part, which in this example takes the form of at least one resiliently-deflectable locking clip 402. The locking clip 402 is configured, when in an extended position, to engage a corresponding region (not shown) on the control module 102 so as to retain the power source module 106 and the control module 102 in an interlocked arrangement. The locking clip 402 is movable from the extended position into a retracted position to release the control module 102. The locking clip 402 is movable from the engaged position into the retracted position by compression applied to a cantilevered region 404 of the housing of the power module 106 at the location indicated by “A”, which causes inward deflection of the locking clip 402 so as to release the locking clip 402 from its engagement with the control module 102.

The power source module 106 is depicted in FIGS. 4A and 4B as including a connector 406 of the type USB-C for connection to a corresponding connector on the control module 102. It will be understood, however, that connection between modules may alternatively be effected via a cable, a metal pin, a universal connector, or connectors such as USB-A, USB-B, USB-mini, USB-micro, SD, miniSD, and microSD, and so on. Furthermore, it will be understood that the module interlock as shown in these figures is not dependent on the connector arrangement.

FIGS. 5A-C illustrate a connector arrangement according to the present disclosure. Illustrated in FIG. 5A is a male connector 500. The male connector 500 corresponds to the connectors 200 and 300 shown in FIGS. 2 and 3 and, in this example, takes the form of a guide pin. The guide pin 500 is configured to form a connector pair with a complementary female connector (not shown). Illustrated in FIG. 5B is a locking clip 550 for use with the corresponding female connector. As shown, the locking clip 550 comprises a protrusion in the form of a ridge 552 which is configured to engage an indentation in the form of a groove 502 in the guide pin 500. The locking clip 550 comprises a cantilever 554 and a base 556 to which the cantilever 554 is mounted. The cantilever 554 is resiliently deflectable to allow the ridge 552 to reversibly engage the groove 502. In particular, the cantilever 554 is resiliently deflectable from an engaged position in which the ridge 552 engages the groove 502 to a released position in which the ridge 552 is disengaged from the groove 502. The locking clip 550 thus helps to restrict the movement of the guide pin 500 when in the engaged position. One or more of the ridge 552 and the groove 502 may comprise a friction-enhancing material, e.g. rubber, for increasing friction therebetween. As shown in FIG. 5C, the base 556 may be mounted to a support surface 560 of the corresponding module at an oblique or tilted angle 558 to generate more grip force to promote engagement between the ridge 552 and groove 502. A plurality of such ridges and grooves may be provided, based for example on the length of the guide pin 500 and/or locking clip 550. The male connector may contain one or more extended parts which can be retracted, for example with compression, to remove the male connector from the female connector. One or both of the guide pin 500 and the locking clip 550 may be made of metal. The locking clip 550 may comprise a lip 559 to facilitate sliding engagement with the guide pin 500.

Referring again to FIG. 5A, the dimensions of the guide pin 500 in the non-limiting example shown are as follows:
a: 3.00 mm (ranged from 1.5 mm to 8.5 mm);
b: 2.0 mm (ranged from 1.2 mm to 2.5 mm);
c: 0.89 mm (ranged from 0.5 mm to 1.5 mm);
d: 0.2 mm (ranged from 0.2 mm to 0.5 mm);
e: 1.05 mm (ranged from 0.85 mm to 1.5 mm);
f: 2.0 mm (ranged from 1.2 mm to 2.5 mm);
g: 0.8 mm (ranged from 0.6 mm to 1.5 mm);
h: 1.0 mm (ranged from 0.6 mm to 1.2 mm).

Referring to FIGS. 5B and 5C, the dimensions of the locking clip 550 in the non-limiting example shown are as follows:
1: 2.5 mm (ranged from 2.0 mm to 4.0 mm);
2: 2.0 mm (ranged from 1.5 mm to 2.5 mm);
3: 4.0 mm (ranged from 2.5 mm to 5.0 mm);
4: 2.0 mm (ranged from 1.5 mm to 2.5 mm);
5: 4.0 mm (ranged from 3.5 mm to 6.0 mm);
6: 2.0 mm (ranged from 1.5 mm to 2.5 mm);
7: 0.6 mm (ranged from 0.4 mm to 1.0 mm);
8: 0.2 mm (ranged from 0.2 mm to 0.5 mm);
9: 1.2 mm (ranged from 1.0 mm to 2.0 mm);
10: 0.4 mm (ranged from 0.35 mm to 2.0 mm).

The angles shown in the non-limiting example of FIG. 5B are as follows:
α: 135° (ranged from 1° to) 160°;
β: 90° (ranged from 65° to) 140°;
γ: 100° (ranged from 95° to) 115°;
τ: 0.5° (ranged from 0° to) 1.5°.

The connector pair is configured to provide a mechanical connection between modules. Optionally, the connector pair may be further configured to provide an electrical and/or optical connection between modules. In this way, the connector pair may be configured to enable transfer of power and/or data between modules. The transfer may be one-way or two-way. For example, the connectors may be configured to allow the transfer of both power and data at the same time. If the connectors only allow transfer of power, data may be transferred via wireless connection, for example, Bluetooth, Wi-Fi, etc. In any of the examples described herein, a module may comprise i) a female connector only; ii) a male connector only; iii) both female and male connectors.

FIG. 6 illustrates a method 600 of controlling a modular aerosol-generating device. The method 600 may be performed for example by the control module 102. The method 600 comprises the steps of controlling 602 a module of a first type (e.g. the heater module 104) coupled to the control module 102; and controlling 604 a module of a second type (e.g. the power source module 106) coupled to the control module 102.

FIG. 7 illustrates a method 700 which may be used to perform step 602 or respectively step 604 of the method 600 of FIG. 6. The method 700 may comprise one or more of the following steps: detecting 702 coupling of the respective module to the control module 102; detecting 704 a subtype of the coupled module; obtaining 706 operating instructions for the coupled module based on the detected subtype, and using 708 the obtained operating instructions to control the coupled module.

FIG. 8 illustrates an exemplary computing system 800 that can be used in accordance with the systems and methods disclosed herein. The computing system 800 may form part of or comprise any desktop, laptop, server, or cloud-based computing system. The computing system 800 includes at least one processor 802 that executes instructions that are stored in a memory 804. The instructions may be, for instance, instructions for implementing functionality described as being carried out by one or more components described herein or instructions for implementing one or more of the methods described herein. The processor 802 may access the memory 804 by way of a system bus 806. In addition to storing executable instructions, the memory 804 may also store conversational inputs, scores assigned to the conversational inputs, etc.

The computing system 800 additionally includes a data store 808 that is accessible by the processor 802 by way of the system bus 806. The data store 808 may include executable instructions, log data, etc. The computing system 800 also includes an input interface 810 that allows external devices to communicate with the computing system 800. For instance, the input interface 810 may be used to receive instructions from an external computer device, from a user, etc. The computing system 800 also includes an output interface 812 that interfaces the computing system 800 with one or more external devices. For example, the computing system 800 may display text, images, etc. by way of the output interface 812.

It is contemplated that the external devices that communicate with the computing system 800 via the input interface 810 and the output interface 812 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing system 800 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing system 800 may be a distributed system. Thus, for instance, several devices may be in communication by way of a network connection and may collectively perform tasks described as being performed by the computing system 800.

Various functions described herein can be implemented in hardware, software, or any combination thereof. If implemented in software, the functions can be stored on or transmitted over as one or more instructions or code on a computer-readable medium. Computer-readable media include computer-readable storage media. Computer-readable storage media can be any available storage media that can be accessed by a computer. By way of example, and not limitation, such computer-readable storage media can comprise FLASH storage media, RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray disc (BD), where disks usually reproduce data magnetically and discs usually reproduce data optically with lasers. Further, a propagated signal may be included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features.

It has to be noted that embodiments of the invention are described with reference to different categories. In particular, some examples are described with reference to methods whereas others are described with reference to apparatus. However, a person skilled in the art will gather from the description that, unless otherwise notified, in addition to any combination of features belonging to one category, also any combination between features relating to different category is considered to be disclosed by this application. However, all features can be combined to provide synergetic effects that are more than the simple summation of the features.

While the invention has been illustrated and described in detail in the drawings and foregoing description, such illustration and description are to be considered exemplary and not restrictive. The invention is not limited to the disclosed embodiments. Other variations to the disclosed embodiments can be understood and effected by those skilled in the art, from a study of the drawings, the disclosure, and the appended claims.

The mere fact that certain measures are recited in mutually different dependent claims does not indicate that a combination of these measures cannot be used advantageously.

Any reference signs in the claims should not be construed as limiting the scope.

1.-15. (canceled)

16. An apparatus comprising a control module for a modular aerosol-generating device, the control module comprising:
a first connector configured to removably operably couple a module of a first type to the control module; and
a second connector configured to removably operably couple a module of a second type to the control module,
wherein the control module is further configured to control the module of the first type, and the module of the second type, when coupled to the control module, and
wherein the control module is further configured to authenticate the module of the first type or the module of the second type coupled to the control module.

17. The apparatus according to claim 16, wherein the control module is further configured to detect a subtype of the module of the first type coupled to the control module and to control the coupled module of the first type based on the detected subtype.

18. The apparatus according to claim 17, wherein the control module is further configured to obtain operating instructions for the coupled module of the first type, or for the coupled module of the second type, based on the detected subtype, and to use the obtained operating instructions to control the coupled module.

19. The apparatus according to claim 16, wherein the control module is further configured to respond to the coupling of the module of the first type or the module of the second type by obtaining and using subtype-appropriate operating instructions for the coupled module.

20. The apparatus according to claim 16, wherein the control module is further configured to authenticate the module of the first type or the module of the second type based on one or more credentials provided to the control module or based on one or more certificates provided to the control module.

21. The apparatus according to claim 16, wherein the module of the first type is one of a plurality of interchangeable modules of the first type, and
wherein the control module is configured to enable a user to reconfigure the modular aerosol generating device by selectively interchanging modules of the first type.

22. The apparatus according to claim 16, wherein at least one of the first connector and the second connector of the control module is configured to form a connector pair with a complementary connector of the module of the first type or with a complementary connector of the module of the second type, and the connector pair is configured to enable transfer of both power and data between the control module and the module of the first type or the module of the second type.

23. The apparatus according to claim 16, wherein at least one of the modules comprises an extendable part configured to be movable between an extended position and a retracted position, and
wherein the extendable part is configured to engage another of the modules when in the extended position and to release the other module when in the retracted position.

24. The apparatus according to claim 23, wherein the extendable part is configured to be movable from the extended position to the retracted position by compression of a region of a housing of the at least one module comprising the extendable part.

25. The apparatus according to claim 16, further comprising the module of the first type and the module of the second type which are couplable to the control module to form a modular aerosol-generating device.

26. An aerosol generating system, comprising:
the aerosol generating device according to claim 25; and
an aerosol generating article.

27. A method of controlling a modular aerosol-generating device, the method comprising:
controlling a module of a first type removably coupled to a control module;
controlling a module of a second type removably coupled to a control module, and
authenticating the module of the first type, or the module of the second type, coupled to the control module.

28. A computing system configured to perform the method according to claim 27.

29. A nontransitory computer-readable medium having stored thereon instructions that, when executed by a computing system, causes the computing system to perform the steps of the method according to claim 27.
